(19) United States
(12) Patent Application Publication
(10) Pub. No.: US 2014/0051609 A1
(43) Pub. Date: Feb. 20, 2014

(54) COMPOSITION FOR PRODUCING OIL

(71) Applicant: Shell Oil Company, Houston, TX (US)

(72) Inventors: Jeffrey George SOUTHWICK, Houston, TX (US); Ronaldus Cornelis Martinus BOUWMEESTER, Kuala Lumpur (MY)

(73) Assignee: Shell Oil Company, Houston, TX (US)

(21) Appl. No.: 13/970,351

(22) Filed: Aug. 19, 2013

Related U.S. Application Data
(60) Provisional application No. 61/691,033, filed on Aug. 20, 2012.

(51) Int. Cl. C09K 8/588

(52) U.S. Cl. CPC C09K 8/588
USPC 507/225

(57) ABSTRACT

A method, system, and composition for producing oil from a formation utilizing an oil recovery formulation comprising a surfactant, an alkali, a polymer, and a paraffin inhibitor are provided.

This present application claims the benefit of U.S. patent application Ser. No. 61/691,033, filed Aug. 20, 2012.

### FIELD OF THE INVENTION

The present invention is directed to a composition for producing oil from a formation, in particular, the present invention is directed to a composition for enhanced oil recovery from a formation.

### BACKGROUND OF THE INVENTION

In the recovery of oil from a subterranean formation, it is possible to recover only a portion of the oil in the formation using primary recovery methods utilizing the natural formation pressure to produce the oil. A portion of the oil that cannot be produced from the formation using primary recovery methods may be produced by improved or enhanced oil recovery (EOR) methods.

One enhanced oil recovery method utilizes an alkaline-surfactant-polymer (“ASP”) flood in an oil-bearing formation to increase the amount of oil recovered from the formation. An aqueous solution of an alkali, a surfactant, and a polymer is injected into an oil-bearing formation to increase recovery of oil from the formation, either after primary recovery or after a secondary recovery waterflood. The ASP flood enhances recovery of oil from the formation by lowering interfacial tension between oil and water phases in the formation, thereby mobilizing the oil for production. Interfacial tension between the oil and water phases in the formation is reduced by the surfactant of the ASP flood and by the formation of soaps by alkali interaction with acids in the oil. The polymer increases the viscosity of the ASP fluid, typically to the same order of magnitude as the oil in the formation, so the mobilized oil may be forced through the formation for production by the ASP flood.

Mobilization of oil in the formation by an ASP flood may result in the formation of a viscous emulsion phase in the formation. This viscous emulsion inhibits or blocks the flow of mobilized oil through the formation, reducing the amount of oil recovered relative to the amount of oil that could be recovered absent the formation of the emulsion. Co-solvents, particularly low molecular weight alcohols, have been used to inhibit the formation of such high viscosity emulsions in an ASP process. Such co-solvents, however, raise the minimum interfacial tension of the oil and water, partially counteracting the effect of the surfactant and alkali and inhibiting mobilization of the oil in the formation. Furthermore, such co-solvents typically have a low flashpoint and introduce safety concerns that must be addressed when utilized. In addition, such co-solvents are typically used in quantities ranging from 5000 ppm to 20000 ppm in ASP formulations, and are relatively expensive.

Improvements to existing ASP enhanced oil recovery methods, compositions, and systems are desirable. In particular, methods, compositions, and systems effective to increase oil production in an ASP enhanced oil recovery method by inhibiting or eliminating the formation of a highly viscous emulsion phase during the ASP process are desirable.

### SUMMARY OF THE INVENTION

The invention is directed to a composition comprising a surfactant, a polymer, an alkali, and a paraffin inhibitor dispersed in a fluid.

### BRIEF DESCRIPTION OF THE DRAWINGS

FIG. 1 is an illustration of a petroleum production system in accordance with the present invention for use in an oil recovery process in accordance with the present invention.

FIG. 2 is a diagram of a well pattern for production of petroleum in accordance with a system and process of the present invention.

FIG. 3 is a diagram of a well pattern for production of petroleum in accordance with a system and process of the present invention.

### DETAILED DESCRIPTION OF THE INVENTION

The present invention is directed to a method and system for enhanced oil recovery from an oil-bearing formation utilizing an oil recovery formulation comprising a surfactant, a polymer, an alkali, and a paraffin inhibitor; and to a composition comprising a surfactant, a polymer, an alkali, and a paraffin inhibitor. The surfactant and the alkali of the oil recovery formulation may mobilize the oil in the formation by reducing interfacial tension between oil and water in the formation, and the polymer may provide the oil recovery formulation with a viscosity sufficient to drive the mobilized oil through the formation for production from the formation. The paraffin inhibitor may inhibit the formation of a viscous paraffin-containing emulsion in the mobilized oil by inhibiting the agglomeration of paraffins in the oil. The mobilized oil, therefore, may flow more freely through the formation for production relative to a mobilized oil in which paraffins enhance the formation of viscous emulsions.

The oil recovery formulation composition provided for use in the method or system of the present invention is comprised of a surfactant, a polymer, an alkali, and a paraffin inhibitor dispersed in a fluid. The fluid of the oil recovery formulation may be water. The water may be fresh water or a brine solution. The water may have a total dissolved solids (TDS) content of from 100 ppm to 100000 ppm. The water may be provided from a water source, where the water source may be a fresh water source having a TDS content of less than 10000 ppm selected from the group consisting of a river, a lake, a fresh water sea, an aquifier, and formation water having a TDS content of less than 10000 ppm, or the water source may be a saline water source having a TDS content of 10000 ppm or greater selected from the group consisting of seawater, brackish water, an aquifer, a brine solution provided by processing a saline water source, and formation water having a TDS content of 10000 ppm or greater.

The TDS content of the oil recovery formulation fluid may be adjusted to optimize the salinity of the fluid for the production of a middle phase, type III, microemulsion of the surfactant and alkali of the oil recovery formulation with oil and formation water in the formation and thereby minimize interfacial tension between oil and water in the formation to maximize mobilization, and therefore, production, of the oil from the formation. The TDS content of the oil recovery formulation fluid may also be adjusted to optimize the viscosity of the oil recovery formulation, since the viscosity of the oil recovery formulation is dependent in part on the viscosity of the polymer in the formulation, which may be dependent on the salinity of the formulation. Determination of the optimum salinity of the oil recovery formulation fluid for minimizing interfacial tension of the oil and water in the oil-bearing formation and for providing a viscosity on the same order of magnitude as the oil in the formation may be conducted according to methods conventional and known to those skilled in the art. One such method is described in WO Pub. No. 2011/090921. Salinity optimization of the water may be conducted in accordance with methods conventional and known to those skilled in the art, for example, by ionic filtration using one or more nanofiltration membrane units, one or more reverse osmosis membrane units, and/or one or more forward osmosis membrane units, and blending of the resulting permeates and retentates to provide optimum salinity. Salinity may also be optimized by simply adding a selected optimum amount of sodium chloride to water produced by de-salination.

The fluid may also be comprised of a co-solvent with water, where the co-solvent may be a low molecular weight alcohol including, but not limited to, methanol, ethanol, and iso-propanol, isobutyl alcohol, secondary butyl alcohol, n-butyl alcohol, t-butyl alcohol, or a glycol including, but not limited to, ethylene glycol, 1,3-propanediol, 1,2-propandiol, diethylene glycol butyl ether, triethylene glycol butyl ether, or a sulfosuccinate including, but not limited to, sodium dihexyl sulfosuccinate. The co-solvent may be utilized for assisting in prevention of formation of a viscous emulsion. The co-solvent, if utilized, may be used for viscous emulsion inhibition in a much smaller quantity than as used in the absence of the paraffin inhibitor. If present, the co-solvent may comprise from 100 ppm to 50000 ppm, or from 500 ppm to 5000 ppm of the oil recovery formulation. A co-solvent may be absent from the oil recovery formulation.

The paraffin inhibitor of the oil recovery formulation may be a compound effective to inhibit or suppress formation of a paraffin-containing emulsion. The paraffin inhibitor may be a compound effective to inhibit or suppress agglomeration of paraffins to inhibit or suppress paraffinic wax crystal growth in the oil of the formation upon contact of the oil recovery formulation with the oil in the formation. The paraffin inhibitor may be any commercially available conventional crude oil pour point depressant or flow improver that is dispersible, and preferably soluble, in the fluid of the oil recovery formulation in the presence of the other components of the oil recovery formulation, and that is effective to inhibit or suppress formation of a paraffin-nucleated emulsion in the oil of the formation. The paraffin inhibitor may be selected from the group consisting of alkyl acrylate copolymers, alkyl methacrylate copolymers, alkyl acrylate vinylpyridine copolymers, ethylene vinylacetate copolymers, maleic anhydride ester copolymers, styrene anhydride ester copolymers, branched polyethylenes, and combinations thereof. Commercially available paraffin inhibitors that may be used in the oil recovery formulation include HiTEC 5714, HiTEC 5788, and HiTEC 672 available from Afton Chemical Corp., 500 Spring St., Richmond, Va. 23219, United States; FLOTRON D1330 available from Champion Technologies, Inc., 3200 Southwest Freeway, Houston, Tex. 77027; and INFINEUM V300 series available from Infineum International Ltd., Milton Hill Business and Technology Centre, P.O. Box 1, Abingdon, Oxfordshire OX13 6BB, United Kingdom.

The paraffin inhibitor is present in the oil recovery formulation in an amount effective to inhibit or suppress formation of a viscous paraffin-containing emulsion when the oil recovery formulation is introduced into an oil-bearing formation and contacted with oil in the formation to mobilize the oil, and the mobilized oil is produced from the formation. The paraffin inhibitor may be present in the oil recovery formulation in an amount of from 5 ppm to 5000 ppm, or from 10 ppm to 1000 ppm, or from 15 ppm to 500 ppm, or from 20 ppm to 300 ppm.

The oil recovery formulation further comprises a surfactant, where the surfactant may be any surfactant effective to reduce the interfacial tension between oil and water in the oil-bearing formation and thereby mobilize the oil for production from the formation. The oil recovery formulation may comprise one or more surfactants. The surfactant may be an anionic surfactant. The anionic surfactant may be a sulfonate-containing compound, a sulfate-containing compound, a carboxylate compound, a phosphate compound, or a blend thereof. The anionic surfactant may be an alpha olefin sulfonate compound, an internal olefin sulfonate compound, a branched alkyl benzene sulfonate compound, a propylene oxide sulfate compound, an ethylene oxide sulfate compound, a propylene oxide-ethylene oxide sulfate compound, or a blend thereof. The anionic surfactant may contain from 12 to 28 carbons, or from 12 to 20 carbons. The surfactant of the oil recovery formulation may comprise an internal olefin sulfonate compound containing from 15 to 18 carbons or a propylene oxide sulfate compound containing from 12 to 15 carbons, or a blend thereof, where the blend contains a volume ratio of the propylene oxide sulfate to the internal olefin sulfonate compound of from 1:1 to 10:1.

The oil recovery formulation may contain an amount of the surfactant effective to reduce the interfacial tension between oil and water in the formation and thereby mobilize the oil for production from the formation. The oil recovery formation may contain from 0.05 wt. % to 5 wt. % of the surfactant or combination of surfactants, or may contain from 0.1 wt. % to 3 wt. % of the surfactant or combination of surfactants.

The oil recovery formulation further comprises an alkali, where the alkali may be any alkali effective to interact with oil in the formation to form a soap effective to reduce the interfacial tension between oil and water in the formation. The oil recovery formulation may comprise one or more alkali compounds. The alkali may be selected from the group consisting of lithium hydroxide, sodium hydroxide, potassium hydroxide, lithium carbonate, sodium carbonate, potassium carbonate, lithium bicarbonate, sodium bicarbonate, potassium bicarbonate, lithium silicate, sodium silicate, potassium silicate, lithium phosphate, sodium phosphate, potassium phosphate, and mixtures thereof.

The oil recovery formulation may contain an amount of the alkali effective to interact with the oil in the formation to form a soap effective to reduce the interfacial tension between oil and water in the formation and thereby mobilize the oil for production from the formation. The oil recovery formulation may contain from 0.001 wt. % to 5 wt. % of the alkali, or from 0.005 wt. % to 1 wt. % of the alkali, or from 0.01 wt. % to 0.5 wt. % of the alkali.

The oil recovery formulation further comprises a polymer, where the polymer may provide the oil recovery formulation with a viscosity on the same order of magnitude as the viscosity of oil in the formation under formation temperature conditions so the oil recovery formulation may drive mobilized oil across the formation for production from the formation with a minimum of fingering of the oil through the oil recovery formulation and/or fingering of the oil recovery formulation through the oil. The oil recovery formulation may comprise a polymer selected from the group consisting of polyacrylamides; partially hydrolyzed polyacrylamides; polyacrylates; ethylenic co-polymers; biopolymers; carboxymethylcelloluses; polyvinyl alcohols; polystyrene sulfonates; polyvinylpyrrolidones; AMPS (2-acrylamide-methyl propane sulfonate); co-polymers of acrylamide, acrylic acid, AMPS, and n-vinylpyrrolidone in any ratio; and combinations thereof. Examples of ethylenic co-polymers include co-polymers of acrylic acid and acrylamide, acrylic acid and lauryl acrylate, and lauryl acrylate and acrylamide. Examples of biopolymers include xanthan gum, guar gum, and scleroglucan.

The quantity of polymer in the oil recovery formulation should be sufficient to provide the oil recovery formulation with a viscosity sufficient to drive the oil through the oil-bearing formation with a minimum of fingering of the oil recovery formulation through the mobilized oil. The quantity of the polymer in the oil recovery formulation may be sufficient to provide the oil recovery formulation with a dynamic viscosity at formation temperatures on the same order of magnitude, or, less preferably a greater order of magnitude, as the dynamic viscosity of the oil in the oil-bearing formation at formation temperatures so the oil recovery formulation may push the oil through the formation. The quantity of the polymer in the oil recovery formulation may be sufficient to provide the oil recovery formulation with a dynamic viscosity of at least 1 mPa s (1 cP), or at least 10 mPa s (10 cP), or at least 100 mPa s (100 cP), or at least 1000 mPa s (1000 cP) at 25° C. or at a temperature within a formation temperature range. The concentration of polymer in the oil recovery formulation may be from 250 ppm to 10000 ppm, or from 500 ppm to 5000 ppm, or from 1000 to 2000 ppm.

The molecular weight average of the polymer in the oil recovery formulation should be sufficient to provide sufficient viscosity to the oil recovery formulation to drive the mobilized oil through the formation. The polymer may have a molecular weight average of at least 10000 daltons, or at least 50000 daltons, or at least 100000 daltons. The polymer may have a molecular weight average of from 10000 to 30000000 daltons, or from 100000 to 15000000 daltons.

In one aspect, the present invention is directed to an oil recovery formulation composition comprising a fluid, a paraffin inhibitor, a surfactant, an alkali, and a polymer. The fluid, paraffin inhibitor, surfactant, alkali, and polymer may be as described above. The oil recovery formulation composition may contain from 5 ppm to 5000 ppm, or from 10 ppm to 1000 ppm, or from 15 ppm to 500 ppm, or from 20 ppm to 300 ppm of the paraffin inhibitor or a combination of paraffin inhibitors; from 0.05 wt. % to 5 wt. % , or from 0.1 wt. % to 3 wt. % of the surfactant or combination of surfactants; from 0.001 wt. % to 5 wt. % , or from 0.005 wt. % to 3 wt. %, or from 0.01 wt. % to 1 wt. % of the alkali or a combination of alkali compounds; and from 250 ppm to 10000 ppm, or from 500 ppm to 5000 ppm, or from 1000 to 2000 ppm of the polymer or a combination of polymers.

In the method of the present invention, the oil recovery formulation is introduced into an oil-bearing formation, and the system of the present invention may include an oil-bearing formation. The oil-bearing formation comprises oil that may be separated and produced from the formation after contact and mixing with the oil recovery formulation. The oil of the oil-bearing formation may contain a significant amount of wax forming paraffinic hydrocarbons. Oils containing significant quantities of wax forming paraffinic hydrocarbons may form viscous emulsions when treated with an alkaline-surfactant-polymer flood in the absence of a paraffin inhibitor. The oil of the oil bearing formation may comprise at least 1 wt. %, or at least 5 wt. %, or at least 10 wt. % or at least 15 wt. % wax forming paraffinic hydrocarbons, or may comprise from 1 wt. % to 50 wt. % wax forming paraffinic hydrocarbons, or from 5 wt. % to 40 wt. % wax forming paraffinic hydrocarbons.

The oil of the oil-bearing formation may have a relatively high cloud point. Oils having a relatively high cloud point may form viscous emulsions when treated with an alkaline-surfactant-polymer flood in the absence of a paraffin inhibitor. The oil of the oil-bearing formation may have a cloud point of at least 15° C., or at least 20° C,. or at least 25° C., and may have a cloud point of from 15° C. to 60° C., or from 20° C. to 55° C. The cloud point of the oil may be determined in accordance with ASTM Method D2500, or ASTM Method D5773 (for oils having a cloud point of 49° C. or below).

The oil may have a cloud point within 5° C. of the minimum temperature of the portion of the formation contacted by the oil recovery formulation as described below. Oils having a cloud point within 5° C. of the minimum temperature of the formation may form a viscous emulsion upon contact with an alkaline-surfactant-polymer flood in the absence of a paraffin inhibitor. The oil may have a cloud point within 10° C., or within 25° C. of the minimum temperature of the portion of the formation contacted by the oil recovery formulation. The minimum temperature of the portion of the formation contacted by the oil recovery formulation may be determined in accordance with conventional methods known to those of skill in the art.

The oil contained in the oil-bearing formation may be a light oil or an intermediate weight oil containing less than 25 wt. %, or less than 20 wt. %, or less than 15 wt. %, or less than 10 wt. %, or less than 5 wt. % of hydrocarbons having a boiling point of at least 538° C. (1000° F.) and having an API gravity of at least 20°, or at least 25°, or at least 30°. The oil of the oil bearing-formation may be a heavy oil containing more than 25 wt. % of hydrocarbons having a boiling point of at least 538° C. and having an API gravity of less than 20°, where the heavy oil is comprised of at least 1 wt. % of wax forming paraffinic hydrocarbons.

The oil contained in the oil-bearing formation may have a dynamic viscosity under formation conditions (in particular, at temperatures within the temperature range of the formation) of at least 1 mPa s (1 cP), or at least 10 mPa s (10 cP), or at least 100 mPa s (100 cP), or at least 1000 mPa s (1000 cP), or at least 10000 mPa s (10000 cP). The oil contained in the oil-bearing formation may have a dynamic viscosity under formation temperature conditions of from 1 to 10000000 mPa s (1 to 10000000 cP).

The oil-bearing formation may be a subterranean formation. The subterranean formation may be comprised of one or more porous matrix materials selected from the group consisting of a porous mineral matrix, a porous rock matrix, and a combination of a porous mineral matrix and a porous rock matrix, where the porous matrix material may be located beneath an overburden at a depth ranging from 50 meters to 6000 meters, or from 100 meters to 4000 meters, or from 200 meters to 2000 meters under the earth's surface. The subterranean formation may be a subsea subterranean formation.

The porous matrix material may be a consolidated matrix material in which at least a majority, and preferably substantially all, of the rock and/or mineral that forms the matrix material is consolidated such that the rock and/or mineral forms a mass in which substantially all of the rock and/or mineral is immobile when oil, the oil recovery formulation, water, or other fluid is passed therethrough. Preferably at least 95 wt. % or at least 97 wt. %, or at least 99 wt. % of the rock and/or mineral is immobile when oil, the oil recovery formulation, water, or other fluid is passed therethrough so that any amount of rock or mineral material dislodged by the passage of the oil, oil recovery formulation, water, or other fluid is insufficient to render the formation impermeable to the flow of the oil recovery formulation, oil, water, or other fluid through the formation. The porous matrix material may be an unconsolidated matrix material in which at least a majority, or substantially all, of the rock and/or mineral that forms the matrix material is unconsolidated. The formation may have a permeability of from 0.0001 to 15 Darcies, or from 0.001 to 1 Darcy. The rock and/or mineral porous matrix material of the formation may be comprised of sandstone and/or a carbonate selected from dolomite, limestone, and mixtures thereof—where the limestone may be microcrystalline or crystalline limestone and/or chalk.

Oil in the oil-bearing formation may be located in pores within the porous matrix material of the formation. The oil in the oil-bearing formation may be immobilized in the pores within the porous matrix material of the formation, for example, by capillary forces, by interaction of the oil with the pore surfaces, by the viscosity of the oil, or by interfacial tension between the oil and water in the formation.

The oil-bearing formation may also be comprised of water, which may be located in pores within the porous matrix material. The water in the formation may be connate water, water from a secondary or tertiary oil recovery process water-flood, or a mixture thereof. The water in the oil-bearing formation may be positioned to immobilize petroleum within the pores. Contact of the oil recovery formulation with the oil and water in the formation may mobilize the oil in the formation for production and recovery from the formation by freeing at least a portion of the oil from pores within the formation by reducing interfacial tension between water and oil in the formation.

In some embodiments, the oil-bearing formation may comprise unconsolidated sand and water. The oil-bearing formation may be an oil sand formation. In some embodiments, the oil may comprise between about 1 wt. % and about 16 wt. % of the oil/sand/water mixture, the sand may comprise between about 80 wt. % and about 85 wt. % of the oil/sand/water mixture, and the water may comprise between about 1 wt. % and about 16 wt. % of the oil/sand water mixture. The sand may be coated with a layer of water with the petroleum being located in the void space around the wetted sand grains. Optionally, the oil-bearing formation may also include a gas, such as methane or air, for example.

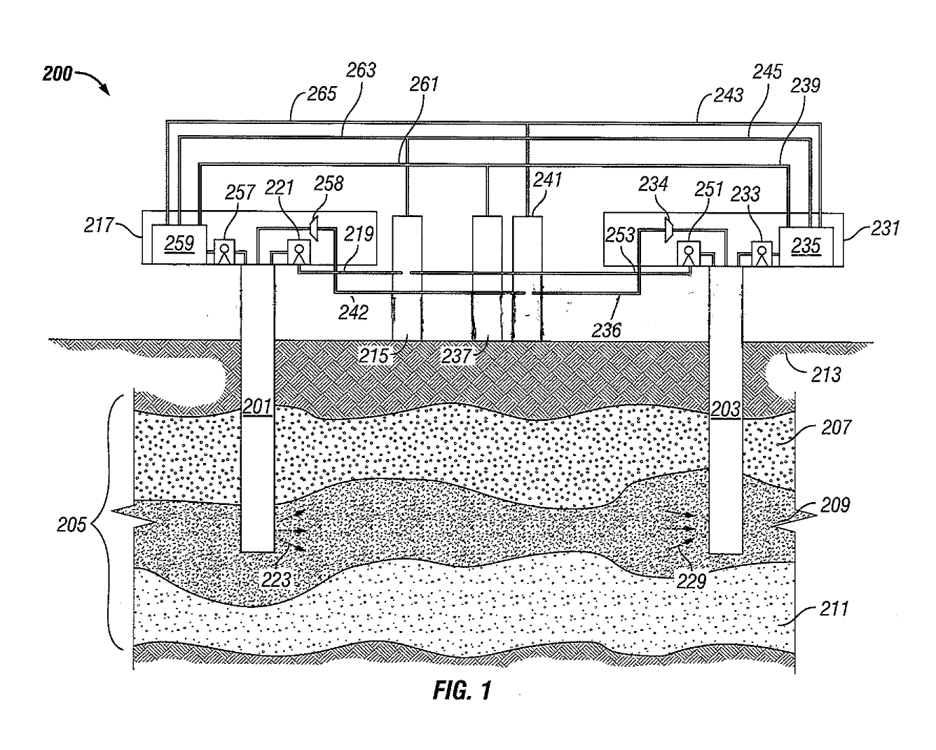

Referring now to FIG. 1, a system 200 of the present invention for practicing a method of the present invention is shown. The system includes a first well 201 and a second well 203 extending into an oil-bearing formation 205 such as described above. The oil-bearing formation 205 may be comprised of one or more formation portions 207, 209, and 211 formed of porous material matricies, such as described above, located beneath an overburden 213.

An oil recovery formulation comprising a fluid as described above, a paraffin inhibitor as described above, a surfactant as described above, an alkali as described above, and a polymer as described above, is provided. The salinity of the oil recovery formulation may be selected and/or adjusted to optimize the capacity of the surfactant and/or the alkali of the oil recovery formulation for reducing interfacial tension between oil and water in the oil-bearing formation, and/or to optimize the viscosity of the oil recovery formulation, as described above. The oil recovery formulation may be provided from an oil recovery formulation storage facility 215 fluidly operatively coupled to a first injection/production facility 217 via conduit 219. First injection/production facility 217 may be fluidly operatively coupled to the first well 201, which may be located extending from the first injection/production facility 217 into the oil-bearing formation 205. The oil recovery formulation may flow from the first injection/production facility 217 through the first well to be introduced into the formation 205, for example in formation portion 209, where the first injection/production facility 217 and the first well, or the first well itself, include(s) a mechanism for introducing the oil recovery formulation into the formation. Alternatively, the oil recovery formulation may flow from the oil recovery formulation storage facility 215 directly to the first well 201 for injection into the formation 205, where the first well comprises a mechanism for introducing the oil recovery formulation into the formation. The mechanism for introducing the oil recovery formulation into the formation 205 via the first well 201—located in the first injection/production facility 217, the first well 201, or both—may be comprised of a pump 221 for delivering the oil recovery formulation to perforations or openings in the first well through which the oil recovery formulation may be introduced into the formation.

The oil recovery formulation may be introduced into the formation 205, for example by injecting the oil recovery formulation into the formation through the first well 201 by pumping the oil recovery formulation through the first well and into the formation. The pressure at which the oil recovery formulation is introduced into the formation may range from the instantaneous pressure in the formation up to, but not including, the fracture pressure of the formation. The pressure at which the oil recovery formulation may be injected into the formation may range from 20% to 95%, or from 40% to 90%, of the fracture pressure of the formation. Alternatively, the oil recovery formulation may be injected into the formation at a pressure equal to, or greater than, the fracture pressure of the formation.

The volume of oil recovery formulation introduced into the formation 205 via the first well 201 may range from 0.001 to 5 pore volumes, or from 0.01 to 2 pore volumes, or from 0.1 to 1 pore volumes, or from 0.2 to 0.6 pore volumes, where the term “pore volume” refers to the volume of the formation that may be swept by the oil recovery formulation between the first well 201 and the second well 203. The pore volume may be readily be determined by methods known to a person skilled in the art, for example by modelling studies or by injecting water or the oil recovery formulation having a tracer contained therein through the formation 205 from the first well 201 to the second well 203.

As the oil recovery formulation is introduced into the formation 205, the oil recovery formulation spreads into the formation as shown by arrows 223. Upon introduction to the formation 205, the oil recovery formulation contacts and forms a mixture with a portion of the oil in the formation. The oil recovery formulation may mobilize the oil in the formation upon contacting and mixing with the oil and water in the formation. The oil recovery formulation may mobilize the oil in the formation upon contacting and mixing with the oil, for example, by reducing capillary forces retaining the oil in pores in the formation, by reducing the wettability of the oil on pore surfaces in the formation, by reducing the interfacial tension between oil and water in the formation, and/or by forming a microemulsion with oil and water in the formation.

Upon introduction of the oil recovery formulation into the formation, the paraffin inhibitor of the oil recovery formulation may interact with the oil and water in the formation and the other components of the oil recovery formulation to inhibit the formation of viscous emulsions containing agglomerated paraffins. The paraffin inhibitor may inhibit formation of viscous emulsions by interacting with paraffins in the oil to inhibit the agglomeration of the paraffins into microcrystalline or crystalline waxes that are capable of forming a viscous emulsion with the oil, water, and oil recovery formulation.

The mobilized mixture of the oil recovery formulation and oil and water may be pushed across the formation 205 from the first well 201 to the second well 203 by further introduction of more oil recovery formulation into the formation. The oil recovery formulation may be designed to displace the mobilized mixture of the oil recovery formulation and oil through the formation for production at the second well 203. As described above, the oil recovery formulation contains a polymer, wherein the oil recovery formulation comprising the polymer may be designed to have a viscosity on the same order of magnitude as the viscosity of the oil in the formation under formation temperature conditions, so the oil recovery formulation may drive the mobilized mixture of oil recovery formulation, oil, and water across the formation while inhibiting fingering of the mixture of mobilized oil and oil recovery formulation through the driving plug of oil recovery formulation and inhibiting fingering of the driving plug of oil recovery formulation through the mixture of mobilized oil and oil recovery formulation.

Oil may be mobilized for production from the formation 205 via the second well 203 by introduction of the oil recovery formulation into the formation, where the mobilized oil is driven through the formation for production from the second well as indicated by arrows 229 by introduction of the oil recovery formulation into the formation via the first well 201. The oil mobilized for production from the formation 205 may include the mobilized oil/oil recovery formulation mixture. Water and/or gas may also be mobilized for production from the formation 205 via the second well 203 by introduction of the oil recovery formulation into the formation via the first well 201.

After introduction of the oil recovery formulation into the formation 205 via the first well 201, oil may be recovered and produced from the formation via the second well 203. The system of the present invention may include a mechanism located at the second well for recovering and producing the oil from the formation 205 subsequent to introduction of the oil recovery formulation into the formation, and may include a mechanism located at the second well for recovering and producing the oil recovery formulation, water, and/or gas from the formation subsequent to introduction of the oil recovery formulation into the formation. The mechanism located at the second well 203 for recovering and producing the oil, and optionally for recovering and producing the oil recovery formulation, water, and/or gas may be comprised of a pump 233, which may be located in a second injection/production facility 231 and/or within the second well 203. The pump 233 may draw the oil, and optionally the oil recovery formulation, water, and/or gas from the formation 205 through perforations in the second well 203 to deliver the oil, and optionally the oil recovery formulation, water, and/or gas, to the second injection/production facility 231.

Alternatively, the mechanism for recovering and producing the oil—and optionally the oil recovery formulation, water, and/or gas—from the formation 205 may be comprised of a compressor 234 that may be located in the second injection/production facility 231. The compressor 234 may be fluidly operatively coupled to a gas storage tank 241 via conduit 236, and may compress gas from the gas storage tank for injection into the formation 205 through the second well 203. The compressor may compress the gas to a pressure sufficient to drive production of oil—and optionally the oil recovery formulation, water, and/or gas—from the formation via the second well 203, where the appropriate pressure may be determined by conventional methods known to those skilled in the art. The compressed gas may be injected into the formation from a different position on the second well 203 than the well position at which the oil—and optionally the oil recovery formulation, water, and/or gas—are produced from the formation, for example, the compressed gas may be injected into the formation at formation portion 207 while oil, oil recovery formulation, water, and/or gas are produced from the formation at formation portion 209.

Oil, optionally in a mixture with the oil recovery formulation, water, and/or gas may be drawn from the formation 205 as shown by arrows 229 and produced up the second well 203 to the second injection/production facility 231. The oil may be separated from the oil recovery formulation, water, and/or gas in a separation unit 235 located in the second injection/production facility 231 and operatively fluidly coupled to the mechanism 233 for producing oil and, optionally, the oil recovery formulation, water, and/or gas, from the formation. The separation unit 235 may be comprised of a conventional liquid-gas separator for separating gas from the oil, oil recovery formulation, and water; and a conventional hydrocarbon-water separator including a demulsification unit for separating the oil from water and water soluble components of the oil recovery formulation.

The separated produced oil may be provided from the separation unit 235 of the second injection/production facility 231 to an oil storage tank 237, which may be fluidly operatively coupled to the separation unit 235 of the second injection/production facility by conduit 239. The separated gas, if any, may be provided from the separation unit 235 of the second injection/production facility 231 to the gas storage tank 241, which may be fluidly operatively coupled to the separation unit 235 of the second injection/production facility 231 by conduit 243.

In an embodiment of a system and a method of the present invention, the first well 201 may be used for injecting the oil recovery formulation into the formation 205 and the second well 203 may be used to produce oil from the formation as described above for a first time period, and the second well 203 may be used for injecting the oil recovery formulation into the formation 205 to mobilize the oil in the formation and drive the mobilized oil across the formation to the first well and the first well 201 may be used to produce oil from the formation for a second time period, where the second time period is subsequent to the first time period. The second injection/production facility 231 may comprise a mechanism such as pump 251 that is fluidly operatively coupled the oil recovery formulation storage facility 215 by conduit 253, and that is fluidly operatively coupled to the second well 203 to introduce the oil recovery formulation into the formation 205 via the second well. The first injection/production facility 217 may comprise a mechanism such as pump 257 or compressor 258 fluidly operatively coupled to the gas storage tank 241 by conduit 242 for production of oil, and optionally the oil recovery formulation, water, and/or gas from the formation 205 via the first well 201. The first injection/production facility 217 may also include a separation unit 259 for separating produced oil, oil recovery formulation, water, and/or gas. The separation unit 259 may be comprised of a conventional liquid-gas separator for separating gas from the produced oil and water; and a conventional hydrocarbon-water separator for separating the produced oil from water and water soluble components of the oil recovery formulation, where the hydrocarbon-water separator may comprise a demulsifier. The separation unit 259 may be fluidly operatively coupled to: the oil storage tank 237 by conduit 261 for storage of produced oil in the oil storage tank; and the gas storage tank 241 by conduit 265 for storage of produced gas in the gas storage tank.

The first well 201 may be used for introducing the oil recovery formulation into the formation 205 and the second well 203 may be used for producing oil from the formation for a first time period; then the second well 203 may be used for introducing the oil recovery formulation into the formation 205 and the first well 201 may be used for producing oil from the formation for a second time period; where the first and second time periods comprise a cycle. Multiple cycles may be conducted which include alternating the first well 201 and the second well 203 between introducing the oil recovery formulation into the formation 205 and producing oil from the formation, where one well is introducing and the other is producing for the first time period, and then they are switched for a second time period. A cycle may be from about 12 hours to about 1 year, or from about 3 days to about 6 months, or from about 5 days to about 3 months.

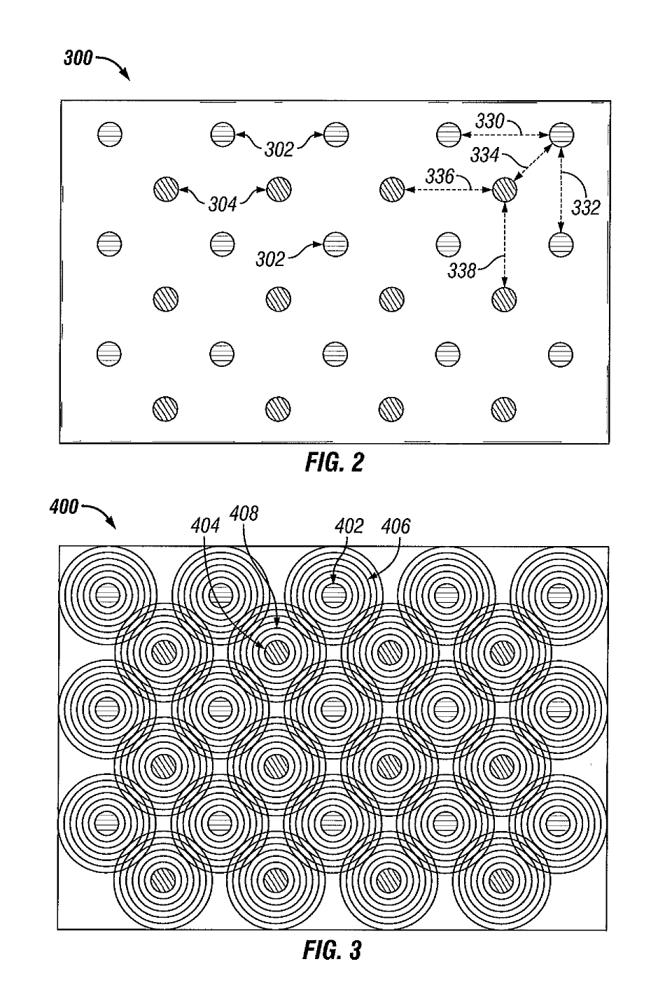

Referring now to FIG. 2, an array of wells 300 is illustrated. Array 300 includes a first well group 302 (denoted by horizontal lines) and a second well group 304 (denoted by diagonal lines). In some embodiments of the system and method of the present invention, the first well of the system and method described above may include multiple first wells depicted as the first well group 302 in the array 300, and the second well of the system and method described above may include multiple second wells depicted as the second well group 304 in the array 300.

Each well in the first well group 302 may be a horizontal distance 330 from an adjacent well in the first well group 302. The horizontal distance 330 may be from about 5 to about 5000 meters, or from about 10 to about 1000 meters, or from about 20 to about 500 meters, or from about 30 to about 250 meters, or from about 50 to about 150 meters, or from about 90 to about 120 meters, or about 100 meters. Each well in the first well group 302 may be a vertical distance 332 from an adjacent well in the first well group 302. The vertical distance 332 may be from about 5 to about 5000 meters, or from about 10 to about 1000 meters, or from about 20 to about 500 meters, or from about 30 to about 250 meters, or from about 50 to about 150 meters, or from about 90 to about 120 meters, or about 100 meters.

Each well in the second well group 304 may be a horizontal distance 336 from an adjacent well in the second well group 304. The horizontal distance 336 may be from 5 to 5000 meters, or from 10 to 1000 meters, or from 20 to 500 meters, or from 30 to 250 meters, or from 50 to 150 meters, or from 90 to 120 meters, or about 100 meters. Each well in the second well group 304 may be a vertical distance 338 from an adjacent well in the second well group 304. The vertical distance 338 may be from 5 to 5000 meters, or from 10 to about 1000 meters, or from 20 to 500 meters, or from 30 to 250 meters, or from 50 to 150 meters, or from 90 to 120 meters, or about 100 meters.

Each well in the first well group 302 may be a distance 334 from the adjacent wells in the second well group 304. Each well in the second well group 304 may be a distance 334 from the adjacent wells in first well group 302. The distance 334 may be from 5 to 5000 meters, or from 10 to 1000 meters, or from 20 to 500 meters, or from 30 to 250 meters, or from 50 to 150 meters, or from 90 to 120 meters, or about 100 meters.

Each well in the first well group 302 may be surrounded by four wells in the second well group 304. Each well in the second well group 304 may be surrounded by four wells in the first well group 302.

In some embodiments, the array of wells 300 may have from 10 to 1000 wells, for example from 5 to 500 wells in the first well group 302, and from 5 to 500 wells in the second well group 304.

In some embodiments, the array of wells 300 may be seen as a top view with first well group 302 and the second well group 304 being vertical wells spaced on a piece of land. In some embodiments, the array of wells 300 may be seen as a cross-sectional side view of the formation with the first well group 302 and the second well group 304 being horizontal wells spaced within the formation.

Referring now to FIG. 3, an array of wells 400 is illustrated. Array 400 includes a first well group 402 (denoted by horizontal lines) and a second well group 404 (denoted by diagonal lines). The array 400 may be an array of wells as described above with respect to array 300 in FIG. 2. In some embodiments of the system and method of the present invention, the first well of the system and method described above may include multiple first wells depicted as the first well group 402 in the array 400, and the second well of the system and method described above may include multiple second wells depicted as the second well group 404 in the array 400.

The oil recovery formulation may be injected into first well group 402 and oil may be recovered and produced from the second well group 404. As illustrated, the oil recovery formulation may have an injection profile 406, and oil may be produced from the second well group 404 having a oil recovery profile 408.

The oil recovery formulation may be injected into the second well group 404 and oil may be produced from the first well group 402. As illustrated, the oil recovery formulation may have an injection profile 408, and oil may be produced from the first well group 402 having an oil recovery profile 406.

The first well group 402 may be used for injecting the oil recovery formulation and the second well group 404 may be used for producing oil from the formation for a first time period; then second well group 404 may be used for injecting the oil recovery formulation and the first well group 402 may be used for producing oil from the formation for a second time period, where the first and second time periods comprise a cycle. In some embodiments, multiple cycles may be conducted which include alternating first and second well groups 402 and 404 between injecting the oil recovery formulation and producing oil from the formation, where one well group is injecting and the other is producing for a first time period, and then they are switched for a second time period.

To facilitate a better understanding of the present invention, the following examples of certain aspects of some embodiments are given. In no way should the following examples be read to limit, or define, the scope of the invention.

### EXAMPLES

An experiment was conducted to determine the effect of utilizing an alkali-surfactant-polymer formulation containing a paraffin inhibitor on oil recovery from a formation relative to oil recovery from a formation utilizing the same alkali-surfactant-polymer formulation without a paraffin inhibitor. A 95 mD Berea sandstone core was flooded with CO₂ to displace air in the pore space of the core. The core was then flooded with a synthetic reservoir brine solution having a total dissolved solids content of about 15,000 ppm and containing 1.47 wt. % NaCl, 0.043 wt. % CaCl₂, and 0.073 wt. % MgCl₂, where the synthetic reservoir brine solution was prepared to have a similar brine composition as formation water from a Malaysian oil-bearing formation. The core was then saturated with oil from the Malaysian formation until no more water was produced upon further introduction of oil to the core. To simulate water flood production of oil from the core, the core was then flooded with the synthetic brine solution at a rate of 1.0 meter/day until no more oil was produced from the core. The amount of residual oil remaining in the core after the waterflood (Sor) was calculated by subtracting the amount of oil recovered as a result of the waterflood from the total amount of oil absorbed by the core during saturation of the core with oil.

For comparative purposes, oil recovery resulting from an alkali-surfactant-polymer flood absent the presence of a paraffin inhibitor was determined. To determine the oil recovery resulting from an alkali-surfactant-polymer flood absent the presence of a paraffin inhibitor, after the waterflood, the core was flooded with 0.5 pore volumes of a solution of a brine containing an alkali, a surfactant, and a polymer at a flow rate of 1 meter/day to produce further oil from the core. The alkali-surfactant-polymer brine solution contained 2 wt. % of sodium carbonate as the alkali, 1300 ppm of FLOPAAM 3300S (an acrylamide and acrylate co-polymer) as the polymer, and 0.48 wt. % Enordet J771(a C₁₂₋₁₃-7PO [propylene oxide] sulfate) plus 0.12 wt. % Enordet 0332 (a C₁₅₋₁₈ internal olefin sulfonate) as the surfactant, and was adjusted to optimal salinity by the addition of NaCl. Following the alkali-surfactant-polymer brine solution flood of the core, the core was flooded with a polymer brine solution having a lower salinity than the ASP brine solution, where the polymer brine solution was formed of 1300 ppm FLOPPAM 3300 in 2 wt. % aqueous NaCl added to the core at a flow rate of 1 meter/day. The core was flooded with the polymer solution until no more oil was produced from the core. The total oil recovery and the clean oil recovery (emulsion-free oil recovered) resulting from the alkali-surfactant-polymer solution flood were determined relative to the residual oil (Sₒᵣ) in the core following the waterflood, and the percentage of residual oil in the core following the alkali-surfactant-polymer solution flood relative to the total oil in the core after water flood was calculated. The results are shown in Table 1 below.

TABLE 1

| | ASP Flood |
|---|---|
| | (no paraffin inhibitor) |
| Clean oil recovery (% of Sₒᵣ) | 64 |
| Total oil recovery (% of Sₒᵣ) | 74.3 |
| Residual oil in core after ASP flood (%) | 10.3 |

An oil recovery flood in accordance with the method and system of the present invention utilizing a composition in accordance with the present invention was performed with exactly the same ASP formulation utilized in the example above except that 1000 ppm of FLOTRON D1330, a paraffin inhibitor, was added to the formulation. A 95 mD Berea sandstone core was prepared as described above by flooding the core with CO₂, then flooding the core with a synthetic reservoir brine solution having the same composition as the synthetic reservoir brine solution utilized in the comparative example above, followed by saturation with oil from the Malaysian formation as described above. A waterflood was conducted as described above, and the amount of residual oil remaining in the core after the waterflood was calculated (Sor) as described above.

The oil recovery resulting from an alkali-surfactant-polymer-paraffin inhibitor flood was determined. To determine the oil recovery resulting from an alkali-surfactant-polymer-paraffin inhibitor flood, the core was flooded with 0.5 pore volumes of an alkali-surfactant-polymer brine solution identical to that used in the comparative example above except for the inclusion of 1000 ppm FLOTRON D1330. Following the alkali-surfactant-polymer-paraffin inhibitor flood of the core, the core was flooded with a polymer brine solution having a lower salinity than the ASP-paraffin inhibitor brine solution until no more oil was produced from the core, where the polymer brine solution was formed of 1300 ppm FLOPPAM 3300 in 2 wt. % aqueous NaCl. The total oil recovery and the clean oil recovery following the oil recovery formulation flood (ASP plus paraffin inhibitor) were determined relative to the residual oil (S_{OR}) in the core following the waterflood. The results are shown in Table 2 below.

TABLE 2

| | ASP Flood |
|---|---|
| | (with paraffin inhibitor) |
| Clean oil recovery (% of S_{OR}) | 93 |
| Total oil recovery (% of S_{OR}) | 97.7 |
| Residual oil in core after ASP flood (%) | 0.9 |

As shown by comparing the results of Table 2 relative to the results of Table 1, the oil recovery formulation containing a paraffin inhibitor in an ASP solution significantly increased the amount of oil recovered from the core relative to oil recovery using an ASP formulation with no paraffin inhibitor, and also significantly increased the amount of clean oil recovered from the core, presumably due to emulsion suppression.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. While systems, methods, and compositions are described in terms of “comprising,” “containing,” or “including” various components or steps, the systems, methods, and compositions can also “consist essentially of” or “consist of” the various components and steps. Whenever a numerical range with a lower limit and an upper limit is disclosed, any number and any included range falling within the range is specifically disclosed. In particular, every range of values (of the form, “from a to b,” or, equivalently, “from a-b”) disclosed herein is to be understood to set forth every number and range encompassed within the broader range of values. Whenever a numerical range having a specific lower limit only, a specific upper limit only, or a specific upper limit and a specific lower limit is disclosed, the range also includes any numerical value “about” the specified lower limit and/or the specified upper limit. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces.

what is claimed is:

1. A composition comprising a surfactant, a polymer, an alkali, and a paraffin inhibitor dissolved in a fluid.

2. The composition of claim 1 wherein the fluid is an aqueous fluid.

3. The composition of claim 1 wherein the surfactant is an anionic surfactant.

4. The composition of claim 1 wherein the polymer is selected from the group consisting of polyacrylamides; partially hydrolyzed polyacrylamides; copolymers of acrylamide, acrylic acid, AMPS (2-acrylamide-methyl propane sulfonate) and n-vinylpyrrolidone in any ratio; polyacrylates; ethylenic co-polymers; biopolymers; carboxymethylcelloluses; polyvinyl alcohols; polystyrene sulfonates; polyvinylpyrrolidones; AMPS; and combinations thereof.

5. The composition of claim 1 wherein the alkali is selected from the group consisting of lithium hydroxide, sodium hydroxide, potassium hydroxide, lithium carbonate, sodium carbonate, potassium carbonate, lithium bicarbonate, sodium bicarbonate, potassium bicarbonate, lithium silicate, lithium phosphate, sodium silicate, sodium phosphate, potassium silicate, potassium phosphate, and combinations thereof.

6. The composition of claim 1 wherein the paraffin inhibitor is selected from the group consisting of alkyl acrylate copolymers, alkyl methacryalate copolymers, alkyl acrylate vinylpyridine copolymers, ethylene vinyl acetate copolymers, maleic anhydride ester copolymers, styrene anhydride ester copolymers, branched polyethylenes, and combinations thereof.

7. The composition of claim 1 wherein the composition comprises from 0.05 wt. % to 5 wt. % of the surfactant, from 250 ppm to 10000 ppm of the polymer, from 0.001 wt. % to 5 wt. % of the alkali, and from 5 ppm to 5000 ppm of the paraffin inhibitor.
